(19) United States
(12) Patent Application Publication
(10) Pub. No.: US 2012/0036012 A1
(43) Pub. Date: Feb. 9, 2012

(54) VARIOUS METHODS AND APPARATUSES FOR INTEGRATING DATA BETWEEN ADVERTISING AND COMMERCE SYSTEM

(76) Inventors: Jesus Manuel Berrios, Sausalito, CA (US); Henry Wong, Sausalito, CA (US); John Underwood, Mill Valley, CA (US)

(21) Appl. No.: 13/027,135

(22) Filed: Feb. 14, 2011

Related U.S. Application Data
(60) Provisional application No. 61/306,325, filed on Feb. 19, 2010.

(51) Int. Cl. G06Q 30/02

(52) U.S. Cl. 705/14.51

(57) ABSTRACT

Certain embodiments of the present invention are directed to a real-time system that integrates data between an advertising system and an ecommerce system. The real-time system includes a distributed commerce platform that receives ecommerce data from the ecommerce system, delivers an ecommerce application to the ecommerce system, and that receives requests from a third party advertisement delivery platform.

### CROSS-REFERENCE TO RELATED APPLICATION

This application claims the benefit of Provisional Application No. 61/306,325, filed Feb. 19, 2010.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### BACKGROUND

In the past, companies could not dynamically modify (i) advertising content to optimize ecommerce conversions or (ii) ecommerce data (e.g., prices) to reflect consumer feedback generated through advertising. In the past, companies could not present, in real-time, complete advertising and ecommerce data in a single, integrated feed or administrative interface.

### BRIEF DESCRIPTION OF THE DRAWINGS

FIG. 1 illustrates a computing device with a resident browser application in which the techniques described may be applied.

FIG. 2 illustrates a network environment in which the techniques described may be applied.

FIG. 3 provides an Ecommerce Adapters Diagram.

FIG. 4 provides a Display Adapters Diagram.

FIG. 5 provides a Communications Flows Diagram.

### DETAILED DISCUSSION

In the following description, numerous specific details are set forth, such as examples of specific routines, named components, connections, internet publishing and advertising technology, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

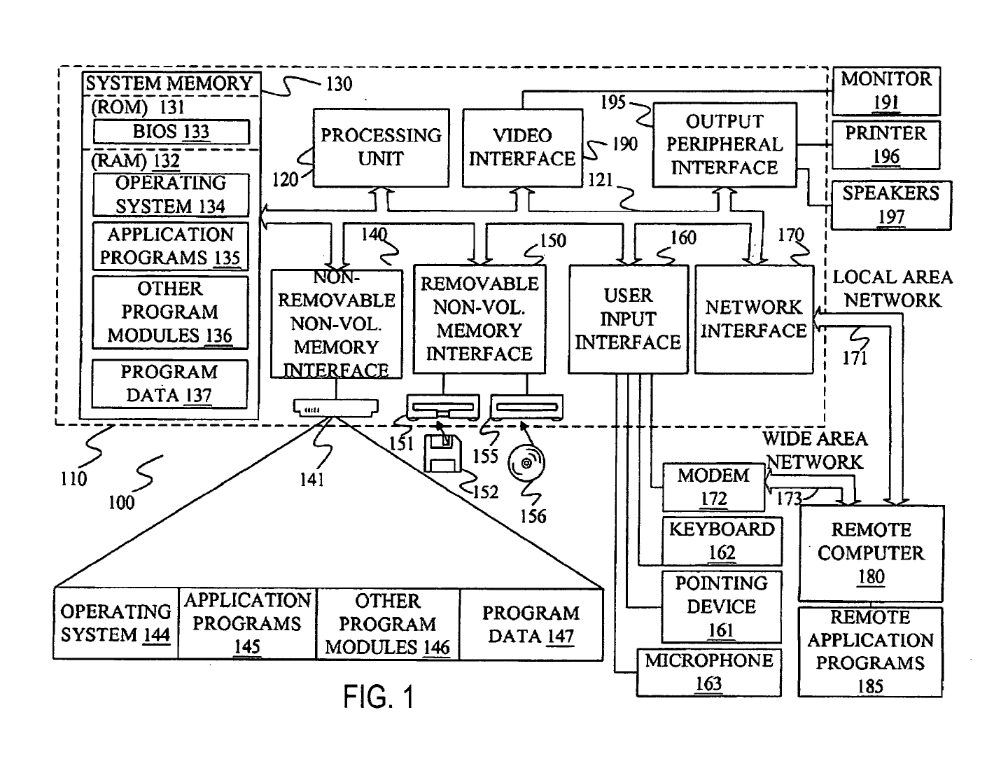

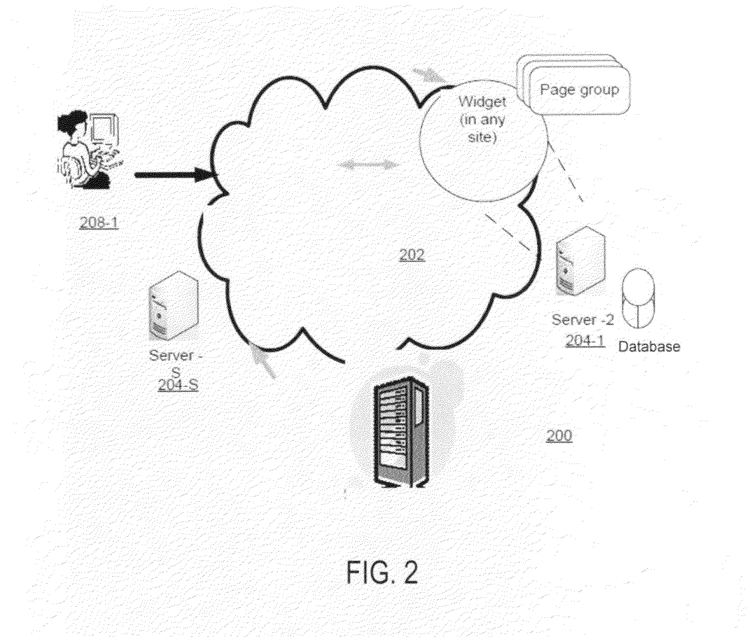

The present design relates to a system and method for a system that integrates data between advertising systems and ecommerce systems in a real-time and intelligent manner, where one or more intelligent adapters transform, enrich, modify and map data as necessary to achieve such integration. The intelligent data adapters give the ability to optimize (dynamically modify) (i) advertising content based on ecommerce data, and (ii) ecommerce content and data based on advertising data. Illustrative environments in which the present design can be used will be discussed in FIGS. 1 and 2.

FIG. 1 illustrates a computing device 110, such as a computer, PDA, iPhone, etc. with a resident browser application in which the techniques described may be applied. More details are described below.

FIG. 2 illustrates a network environment 200 in which the techniques described may be applied. The network environment 200 has a network 202 that connects S number of servers 204-1 through 204-S, and C number of clients 208-1 through 208-C. More details are described below.

The system integrates data between advertising systems and ecommerce systems. Advertising systems can consist of servers that store and serve advertising content and client browsers that display advertising content. Ecommerce systems can consist of servers that store, process and serve commerce data (including product, customer and transaction information and payment services) and client browsers that provide an interface for consumers to interact with the ecommerce servers.

The system uses intelligent adapters. The intelligent adapters transform, enrich, modify and map data, can, in near real-time and in the following order, (1) transmit data from an ecommerce system (e.g., product pricing) through an advertising system and into an advertising unit, (2) transmit ecommerce data generated within such advertising unit back into such ecommerce system, (3) receive response data from such ecommerce system (e.g., confirmation of purchase), and (4) process such response data in order to modify the content displayed in such advertising unit or other advertising units (e.g., by changing the products or pricing thereof featured in such advertising unit). The system can additionally present in real-time combined ecommerce and advertising analytical data (e.g., impressions, add-to-carts, conversions) in a single feed or administrative interface.

The design allows, in real time, to apply data generated from both advertising and ecommerce into a single optimized system. In the past, companies could not, in real time, apply data generated from both advertising and ecommerce into a single optimized system. As a result, the design dynamically modifies (i) advertising content to optimize ecommerce conversions or (ii) ecommerce data (e.g., prices) to reflect consumer feedback generated through advertising. In the past, companies could not dynamically modify (i) advertising content to optimize ecommerce conversions or (ii) ecommerce data (e.g., prices) to reflect consumer feedback generated through advertising. The design also presents in real-time complete advertising and ecommerce data in a single, integrated feed or administrative interface.

Advertisement Server Intelligent Ecommerce Optimization Adapters:

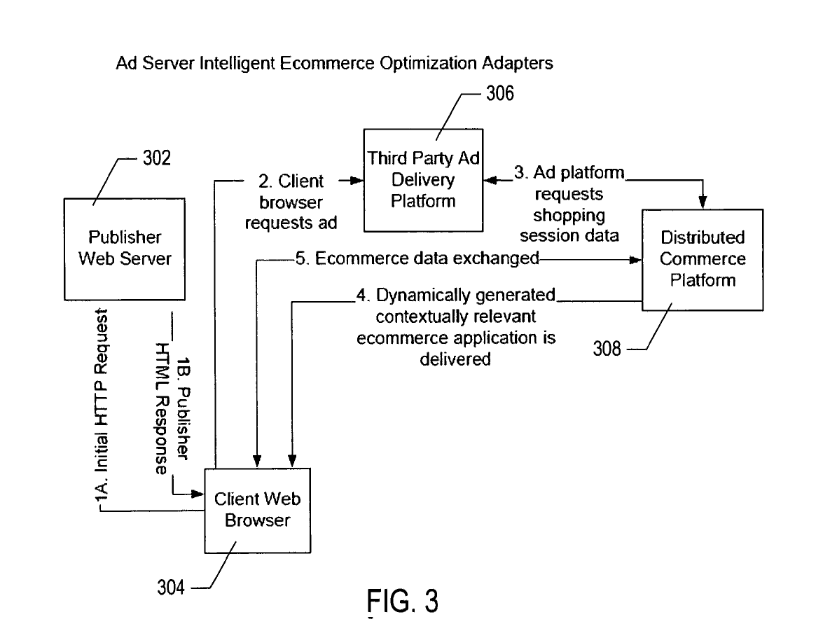

FIG. 3 illustrates an Ecommerce Adapters Diagram. The Ecommerce Adapters Diagram illustrates how data can be transmitted between an advertising system and an ecommerce system, via adapters contained in a Distributed Commerce Platform, in order to enable the ecommerce system to dynamically generate contextually relevant ecommerce applications and content based on data received from an advertising system. The Publisher Web Server 302 in this instance publishes ecommerce content to the Client Web Browser 304 and instructs such Client Web Browser to, via a Third Party Advertising Delivery Platform 306, detect whether there is shopping session data available from the Distributed Commerce Platform 308 associated with such Client Web Browser. If there is such data, then the Publisher Web Server can modify the ecommerce content displayed in the Client Web Browser based on the ecommerce information associated with such active session.

Some example steps of in the diagram are as follows.

1. The Client Web Browser makes an initial HTTP request to the Publisher Web Server (1A), and the Publisher Web Server sends an HTML response (1B).
2. The Client Web Browser requests advertisement from the Third Party Advertisement Delivery Platform.
3. The Third Party Advertisement Delivery Platform requests shopping session data from the Distributed Commerce Platform.
4. The Distributed Commerce Platform delivers an ecommerce application to the Client Web Browser. Thus, the dynamically generated contextually relevant ecommerce application is delivered.
5. The Client Web Browser exchanges data with the Distributed Commerce Platform in order to initiate and complete a transaction.

### Advertisement Server Intelligent Display Optimization Adapters

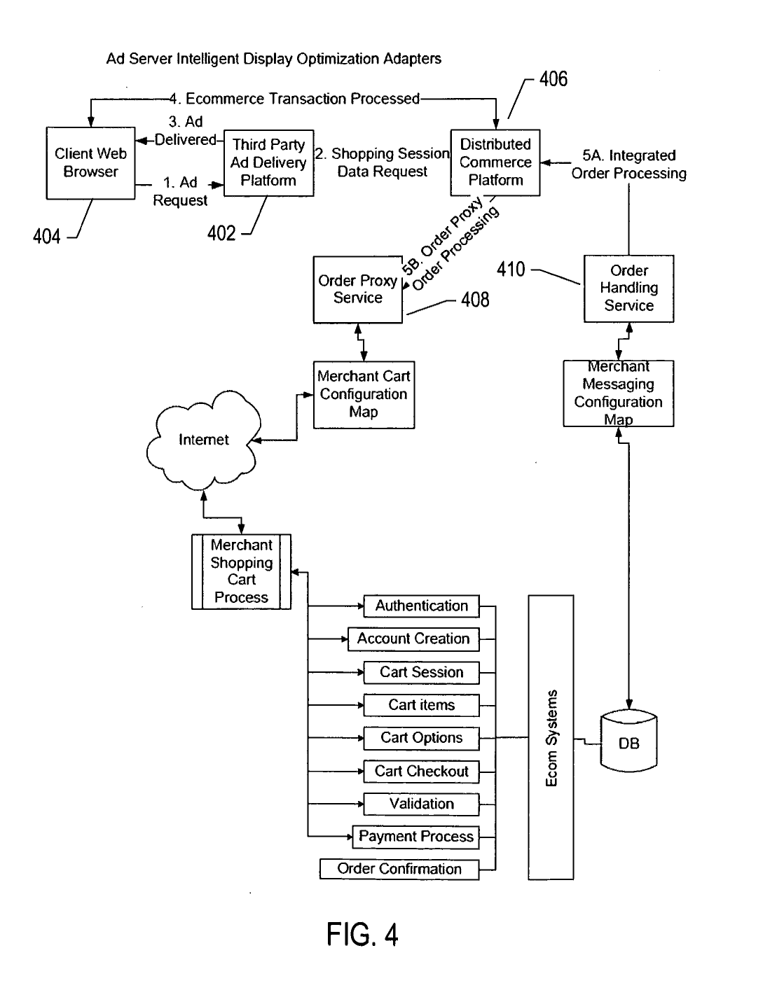

FIG. 4 illustrates a Display Adapters Diagram. The Display Adapters Diagram illustrates how data can be transmitted between an advertising system and an ecommerce system, via adapters contained in a Distributed Commerce Platform, in order to enable the advertising system to dynamically optimize advertising content based on data received from an ecommerce system. The Third Party Advertising Delivery Platform 402 in this instance publishes advertisements to the Client Web Browser 404 and instructs such Client Web Browser to detect whether there is shopping session data available from the Distributed Commerce Platform associated with such Client Web Browser. If there is such data, then the Third Party Advertising Delivery Platform can modify the advertisements displayed in the Client Web Browser based on the ecommerce information associated with such active session.

Some example steps of in the diagram are as follows.

1. The Client Web Browser makes an advertisement request to the Third Party Advertisement Delivery Platform.
2. The Third Party Advertisement Delivery Platform requests shopping session data from the Distributed Commerce Platform 406.
3. The Third Party Advertisement Delivery Platform delivers the advertisement to Client Web Browser based on the shopping session data.
4. The Client Web Browser exchanges data with the Distributed Commerce Platform in order to initiate and complete a transaction.
5. The Distributed Commerce Platform may complete the transaction via integration into a merchant's order processing system (5A) or via (5B) an order proxy system 408.
6. In the merchant's order processing system (5A), integrated order processing is passed to the Order Handling service 410. The merchant messaging configuration map exchanges the information with a database.
7. In the order proxy system 408, the following example operations may occur.
8. The order proxy system enables any ecommerce shopping cart to submit and complete transaction orders into any commerce system without there being any prior integration between such shopping cart and such commerce system.
9. For an ecommerce shopping cart to properly transmit transaction orders it must be able to communicate with the corresponding commerce system in order to complete the necessary steps for completing the transactions, which may include receiving product information (such as price and available quantity), transmitting consumer information (such as name and address), authenticating or registering the user, transmitting payment information, and receiving confirmation or rejection of payment completion. This communication is currently completed via various methods of software integration (such as the use of application programming interfaces). By routing a transaction order through an order proxy system, this design enables such communication without any form of software integration between the ecommerce shopping cart and the ecommerce system.
10. This design enables an ecommerce shopping cart to communicate with a commerce system without software integration. Eliminating such integration would enable the rapid deployment of ecommerce shopping carts that are compatible with any commerce system.
11. The design will be implemented in ecommerce digital shopping carts that could be deployed on websites, rich media advertisements, Internet-connected applications, and mobile applications. The design will enable any merchant to more quickly deploy such shopping carts by eliminating direct software integration. Shopping cart software is software used in e-commerce to assist people making purchases online. The Shopping cart software allows online shopping customers to accumulate a list of items for purchase, described metaphorically as “placing items in the shopping cart”. Upon checkout, the software typically calculates a total for the order, including shipping and handling (i.e. postage and packing) charges and the associated taxes, as applicable.

### Advertisement Server Intelligent Ecommerce Adapters Communication Flows:

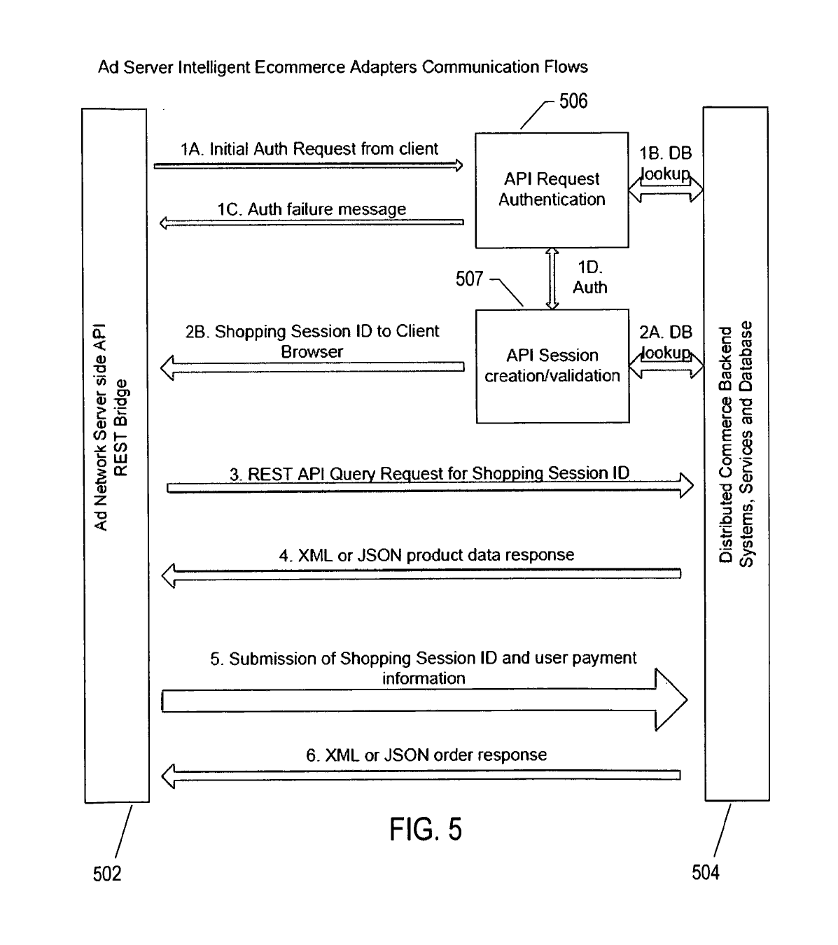

FIG. 5 illustrates a Communications Flows Diagram. The Communications Flows Diagram illustrates how data flows between an advertising system 502 and an ecommerce system 504 via an intelligent adapter system consisting of application programming interface (API)506-507. The Advertisement Networks System, via an adapter API, initiates and completes a series of communications with the Distributed Commerce System in order to complete a commerce transaction, including initiating a commerce session, communicating transaction data, and confirming transaction processing.

Some example steps of in the diagram are as follows.

1. The Advertisement Network Server side via the API, initiates an authentication session with the Distributed Commerce Platform via request (1A), database lookup (1B), and then failure (1C) or successful authentication (1D). The Distributed Commerce Platform includes Distributed Commerce Backend Systems, Services and Databases.
2. The Shopping session ID is generated via database lookup (2A) and submission of an ID to the Advertisement Network (2B).
3. The Advertisement Network, via API request, returns the shopping session ID.
4. The Distributed Commerce Platform delivers product data to the Advertisement Network. For example, the Distributed Commerce Platform delivers an XML or JSON product data response.
5. The Advertisement Network delivers the shopping session ID and user payment information to the Distributed Commerce Platform.
6. The Distributed Commerce Platform delivers an order response (success or failure) to the Advertisement Network. For example, the Distributed Commerce Platform delivers an XML or JSON order response.

The design, through the use of intelligent adapters that can transform, enrich, modify and map data, enables data to be completely and instantly shared between advertising systems and ecommerce systems. No other system can enable complete and instant sharing of advertising and ecommerce data.

Online commerce growth depends on advertising. However, advertising today is an inefficient vehicle for driving commerce growth as the feedback cycle between the two systems is slow and incomplete. The design, by integrating the data between the two systems, enables an instant feedback cycle.

Functionally, the design enables advertising content to be optimized for achieving ecommerce objectives by real-time updating advertising content to reflect ecommerce data generated through the advertising unit. Vice versa, the ecommerce system can modify its data to reflect consumer activity in the advertising unit. Finally, the invention enables real-time commerce and advertising data to be presented in a single administrative interface.

FIG. 1 illustrates a block diagram of an example computer system that may use an embodiment of one or more of the software applications discussed herein. The computing system environment 100 is only one example of a suitable computing environment and is not intended to suggest any limitation as to the scope of use or functionality of the design. Neither should the computing environment 100 be interpreted as having any dependency or requirement relating to any one or combination of components illustrated in the exemplary operating environment 100.

The design is operational with numerous other general purpose or special purpose computing system environments or configurations. Examples of well known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The design may be described in the general context of computing device executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The design may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing the design includes a general-purpose computing device in the form of a computer 110. Components of computer 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet. A browser application may be resident on the computing device and stored in the memory.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present design can be carried out on a computer system such as that described with respect to FIG. 1. However, the present design can be carried out on a server, a computer devoted to message handling, or on a distributed system in which different portions of the present design are carried out on different parts of the distributed computing system.

Another device that may be coupled to bus 111 is a power supply such as a battery and Alternating Current adapter circuit. As discussed above, the DC power supply may be a battery, a fuel cell, or similar DC power source that needs to be recharged on a periodic basis. The wireless communication module 172 may employ a Wireless Application Protocol to establish a wireless communication channel. The wireless communication module 172 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

Referring back to FIG. 2, FIG. 2 illustrates a network environment 200 in which the techniques described may be applied. The network environment 200 has a network 202 that connects S servers 204-1 through 204-S, and C clients 208-1 through 208-C. As shown, several systems in the form of S servers 204-1 through 204-S and C clients 208-1 through 208-C are connected to each other via a network 202, which may be, for example, an on-chip communication network. Note that alternatively the network 202 might be or include one or more of: inter-chip communications, an optical network, the Internet, a Local Area Network (LAN), Wide Area Network (WAN), satellite link, fiber network, cable network, or a combination of these and/or others. The servers may represent, for example: a master device on a chip; a memory; an intellectual property core, such as a microprocessor, communications interface, etc., a disk storage system, and/or computing resources. Likewise, the clients may have computing, storage, and viewing capabilities. The method and apparatus described herein may be applied to essentially any type of communicating means or device whether local or remote, such as a LAN, a WAN, a system bus, on-chip bus, etc. It is to be further appreciated that the use of the term client and server is for clarity in specifying who initiates a communication (the client) and who responds (the server). No hierarchy is implied unless explicitly stated. Both functions may be in a single communicating device, in which case the client-server and server-client relationship may be viewed as peer-to-peer. Thus, if two devices such as 208-1 and 204-S can both initiate and respond to communications, their communication may be viewed as peer-to-peer. Likewise, communications between 204-1 and 204-S, and 208-1 and 208-C may be viewed as peer to peer if each such communicating device is capable of initiation and response to communication.

FIG. 2 also illustrates a block diagram of an embodiment of a server to display the application on a portion of a media space, such as a web page, a profile page on a social network site, etc. The application may be embedded into a third party's media space, such as an HTML web page, a page of a social network platform, etc. The application, when executed on a server 204, causes the server 204 to display windows and user interface screens on a portion of a media space such as a web page. A user from a client machine 208 may interact with the page that contains the embedded application, and then supply input to the query/fields and/or service presented by a user interface of the application. The web page may be served by a web server 204 on any HTML or WAP enabled client device 208 or any equivalent thereof such as a mobile device or personal computer. The client device 208 may host a browser to interact with the server. Each application, widget, Plug in, etc. has a code scripted to perform the functions that the software component is coded to carry out such as presenting fields and icons to take details of desired information. The intelligent application may be implemented as a viral web application hosted on the server and served to the browser of the client machine 208 of the customer. The intelligent application then serves pages that allow entry of details and further pages that allow entry of more details.

A portable application and other scripted code components may be stored on a computer readable medium which, when executed on the server causes the server to display the application on a portion of a media space. The media space may be web pages, social network platforms, etc. hosted on a server.

In an embodiment, the software used to facilitate the functions and processes described herein can be embodied onto a machine-readable medium such as computer readable medium. As discussed above a computer-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Algorithms, procedures, routines, or programs as described herein in this application may also be included as variants of the portable application and security mechanism.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These routines, algorithms, etc. may be written in a number of different programming languages. Also, an algorithm may be implemented with lines of code in software, configured logic gates in software, or a combination of both. The portable application and its security mechanisms may be scripted in any number of software program languages.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown, the invention is not to be limited to these embodiments. The invention is to be understood as not limited by the specific embodiments described herein, but only by the scope of the appended claims.

1. A real-time system that integrates data between an advertising system and an ecommerce system, the real-time system comprising:
a distributed commerce platform that receives ecommerce data from the ecommerce system, delivers an ecommerce application to the ecommerce system, and that receives requests from a third party advertisement delivery platform.
